(19) United States
(12) Patent Application Publication
(10) Pub. No.: US 2025/0304041 A1
(43) Pub. Date: Oct. 2, 2025

(54) VEHICLE COLLISION MITIGATION APPARATUS

(71) Applicant: SUBARU CORPORATION, Tokyo (JP)

(72) Inventor: Takuya IWASE, Tokyo (JP)

(73) Assignee: SUBARU CORPORATION, Tokyo (JP)

(21) Appl. No.: 19/021,575

(22) Filed: Jan. 15, 2025

(30) Foreign Application Priority Data
Mar. 26, 2024 (JP) 2024-050035

(51) Int. Cl. B60W 30/09; B60W 10/18; B60W 10/20; B60W 30/095; B60W 50/00

(52) U.S. Cl. CPC B60W 30/09; B60W 10/18; B60W 10/20; B60W 30/0953; B60W 50/0097; B60W 30/0956; B60W 2520/00

(57) ABSTRACT

A vehicle collision mitigation apparatus includes: an on-board sensor including an accelerometer; and a controller configured to execute a collision mitigation process. The controller is configured to set a central position of the vehicle as a calculation starting-point position for a predicted course of the vehicle that is turning, and calculate an amount of movement made by the vehicle making a turn from the calculation starting-point position and a post-movement position, by using information based on a detection by the on-board sensor, or an actual moving velocity of the turning vehicle. The actual moving velocity is oriented in a direction of a sideslip angle of the turning vehicle. The controller is configured to predict and determine interference with an obstacle to traveling, assuming that the vehicle moves along the predicted course, and execute the collision mitigation process when it is predicted and determined that the interference will occur.

### CROSS-REFERENCE TO RELATED APPLICATIONS

The present application claims priority from Japanese Patent Application No. 2024-050035 filed on Mar. 26, 2024, the entire contents of which are hereby incorporated by reference.

### BACKGROUND

The disclosure relates to a vehicle collision mitigation apparatus.

For example, vehicles include automobiles that travel roads. An automobile travels along a road through operation of the automobile by a driver who drives an automobile, or through autonomous driving.

The road is also used by other moving objects, such as other vehicles, pedestrians, and bicycles. There is a possibility that a vehicle collides with another moving object or the like during travel.

Accordingly, for a vehicle, a collision mitigation apparatus has been proposed (Japanese Unexamined Patent Application Publication (JP-A) No. 2008-094213). The collision mitigation apparatus is configured to predict and determine interference between an obstacle to traveling, such as another moving object, and the vehicle. When it is predicted and determined that interference will occur between the vehicle and the obstacle to traveling, the collision mitigation apparatus executes a collision mitigation process and causes a braking device of the vehicle to operate.

### SUMMARY

A vehicle collision mitigation apparatus according to one aspect of the disclosure is configured to cause a braking device or a steering system of a vehicle to operate and mitigate collision of the vehicle. The vehicle collision mitigation apparatus includes one or more on-board sensors and a controller. The one or more on-board sensors are provided in the vehicle and include an accelerometer configured to perform a detection of at least an acceleration rate of the vehicle as a traveling state of the vehicle. The controller is configured to acquire information based on a detection by the one or more on-board sensors and execute a collision mitigation process of causing one or both of the braking device and the steering system of the vehicle to operate. The controller is configured to set a central position of the vehicle as a calculation starting-point position for a predicted course of the vehicle that is turning. The controller is configured to generate the predicted course of the vehicle that is turning by calculating an amount of movement made by the vehicle making a turn from the calculation starting-point position and calculating a post-movement position, by using the information based on the detection by the one or more on-board sensors, or an actual moving velocity of the vehicle that is turning. The actual moving velocity is oriented in a direction of a sideslip angle of the vehicle that is turning, and the sideslip angle is calculated based on the information based on the detection by the one or more on-board sensors. The controller is configured to predict and determine interference with an obstacle to traveling, assuming that the vehicle moves along the predicted course of the vehicle that is turning. The controller is configured to, when the controller predicts and determines that the interference with the obstacle to traveling will occur, execute the collision mitigation process of causing one or both of the braking device and the steering system to operate.

A vehicle collision mitigation apparatus according to one aspect of the disclosure is configured to cause a braking device or a steering system of a vehicle to operate and mitigate collision of the vehicle. The vehicle collision mitigation apparatus includes at least one processor and one or more on-board sensors provided in the vehicle. The one or more on-board sensors include an accelerometer configured to perform a detection of at least an acceleration rate of the vehicle as a traveling state of the vehicle. The at least one processor is configured to set a central position of the vehicle as a calculation starting-point position for a predicted course of the vehicle that is turning. The at least one processor is configured to generate the predicted course of the vehicle that is turning by calculating an amount of movement made by the vehicle making a turn from the calculation starting-point position and calculating a post-movement position, by using information based on a detection by the one or more on-board sensors, or an actual moving velocity of the vehicle that is turning. The actual moving velocity is oriented in a direction of a sideslip angle of the vehicle that is turning, and the sideslip angle being calculated based on the information based on the detection by the one or more on-board sensors. The at least one processor is configured to predict and determine interference with an obstacle to traveling, assuming that the vehicle moves along the predicted course of the vehicle that is turning. The at least one processor is configured to, when the at least one processor predicts and determines that the interference with the obstacle to traveling will occur, execute a collision mitigation process of causing one or both of the braking device and the steering system to operate.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an explanatory diagram of a state in which an automobile to which a vehicle collision mitigation apparatus according to the disclosure is applicable is traveling on a straight road, and an example of general collision mitigation control in such a case;

FIG. 2 is an explanatory diagram of a state in which the automobile in FIG. 1 is traveling on a bent curve of a road, and an example of general collision mitigation control in such a case;

FIG. 3 is a basic configuration diagram of an automobile control system that serves as a vehicle collision mitigation apparatus according to an embodiment of the disclosure;

FIG. 4 is a basic configuration diagram of an AEBS apparatus that performs collision mitigation control in FIG. 3;

FIG. 5 is a flowchart illustrating a basic flow of the collision mitigation control that is executed by a CPU of the AEBS apparatus in FIG. 4;

FIG. 6 is an explanatory diagram with regard to various geometric matters of an automobile that is turning;

FIG. 7 is a geometric explanatory diagram of a method of calculating a sideslip angle J;

FIG. 8 is a flowchart of control for generation of a predicted course the turning automobile in the present embodiment;

FIG. 9 is an explanatory diagram of an example of the predicted course of the turning automobile in the present embodiment;

FIG. 10 is a flowchart of control for determination of interference between the predicted course of the turning automobile and an obstacle to traveling in the present embodiment;

FIG. 11 is an explanatory diagram of an example of an interference determination plane corresponding to the predicted course of the turning automobile, which is used in the determination of interference; and

FIG. 12 is an explanatory diagram of a state in which an automobile is traveling on a bent curve of a road under control in the present embodiment, and an example of collision mitigation control in such a case.

### DETAILED DESCRIPTION

It is not easy to predict and determine interference with an obstacle to traveling, such as another moving object, that can actually happen to a vehicle.

For example, when a vehicle is traveling on a straight road at stable speed, it is relatively easy to predict a course that is less likely to deviate from an actual course on which the vehicle will actually move.

In contrast, when a vehicle is traveling on a curve or the like, it is difficult to predict a course that is less likely to deviate from an actual course. In particular, when a vehicle is traveling on a downhill curve or an uphill curve, not a curve on level ground, it is difficult to predict a turning course of a vehicle that is less likely to deviate from an actual course. Moreover, when acceleration or deceleration is performed in the middle of a curve, it is also difficult to predict a turning course of a vehicle that is less likely to deviate from an actual course. In such traveling states, for example, when a predicted course of a vehicle that is turning is calculated by using the position of the center of gravity, or the position of the neutral steer point, of the vehicle for a fixed calculation starting-point position in a case where it is assumed that the vehicle will move from the calculation starting-point position through steady-state circular turning, a deviation from an actual course can be large.

As a result, a collision mitigation apparatus of the vehicle tends to determine interference with an obstacle to traveling excessively or insufficiently. There can arise a possibility that smooth and safe traveling of the vehicle is hindered.

As described above, improvement of a vehicle collision mitigation apparatus is sought to be made in such a manner as to enhance the accuracy of a predicted course of a vehicle that is turning and make it difficult for smooth and safe traveling of the turning vehicle to be hindered.

Hereinafter, an embodiment of the disclosure is described based on the drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

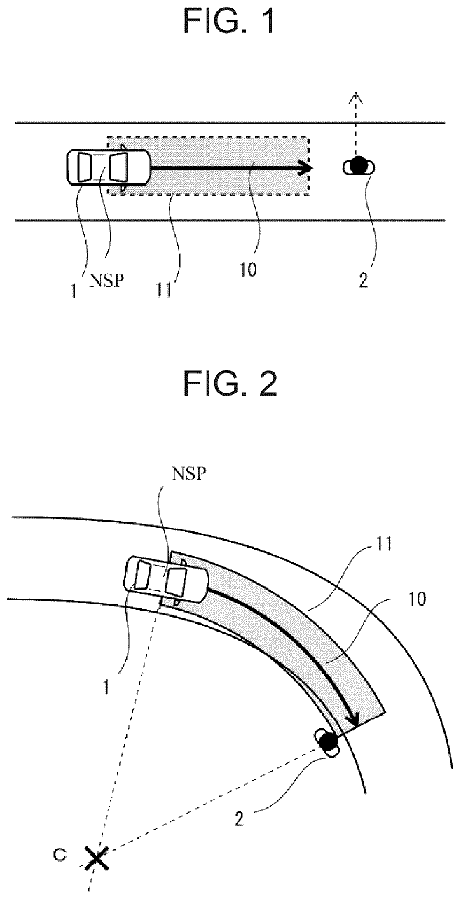

FIG. 1 is an explanatory diagram of a state in which an automobile 1 to which a vehicle collision mitigation apparatus according to the disclosure is applicable is traveling on a straight road, and an example of general collision mitigation control in such a case.

The automobile 1 in FIG. 1 is traveling on a straight road. The automobile 1 is an example of a vehicle. Apart from automobiles, vehicles include, for example, large commercial vehicles, buses, motorcycles, bicycles, and personal mobility devices.

FIG. 2 is an explanatory diagram of a state in which the automobile 1 in FIG. 1 is traveling on a bent curve of a road, and an example of general collision mitigation control in such a case.

In the case, a control system 50 of the automobile 1 changes the directions of front wheels according to steering operation by an occupant. The automobile 1 travels, while changing the orientation thereof, along the curvature of the road.

In contrast, in FIG. 1, the occupant basically does not perform steering operation. The automobile 1 travels along the straight road, basically without changing the orientation thereof.

Additionally, it is becoming more common for the automobile 1 to be able to travel with driving assistance or through autonomous driving by the control system 50.

The road is also used by other moving objects, such as other automobiles, pedestrians, and bicycles. In FIG. 1, a pedestrian 2 is illustrated who is crossing the road. In FIG. 2, a pedestrian 2 is illustrated who is standing on a side of the road. There is a possibility that the automobile 1 collides with another moving object, such as the pedestrian 2, while the automobile 1 is traveling. Moreover, there are some cases where the automobile 1 interferes with curbstone of a shoulder that is not level with a lane. Further, there is a possibility that fixed objects, such as a road stud, a manhole cover, and a bump, also disturb traveling of the automobile 1.

Accordingly, for example, a VDC apparatus 55, an AEBS apparatus 56, and the like are provided in the control system 50 of the automobile 1 in some cases, for traveling control by intervention that is not based on operation by the occupant, which will be described later.

The VDC apparatus 55 is an apparatus for controlling vehicle dynamics. When it is determined, based on information on behavior of the automobile 1 that is traveling, that a slip is occurring, for example, during travel on a curve or the like, the VDC apparatus 55 controls driving force of a drive line 63 and braking force of a braking device 61 of the automobile 1. Thus, the pose of the automobile 1 that is traveling on the curve or the like, or is traveling on a slippery road surface, can be stabilized through the intervening control by the VDC apparatus 55.

The AEBS apparatus 56 is an apparatus that performs control for pre-crash braking. When it is determined, based on information on behavior of the automobile 1 that is traveling, that interference will occur, for example, with an obstacle to traveling, such as a leading vehicle, the AEBS apparatus 56 causes the braking device 61 of the automobile 1 to operate and controls the braking force. Moreover, the AEBS apparatus 56 may perform control for interference reduction steering by using a steering system 62 of the automobile 1. Thus, the automobile 1, which is predicted to interfere with the obstacle to traveling during travel, can safely travel, for example, in such a manner as not to actually interfere with the obstacle to traveling.

By including the apparatuses that perform traveling control by intervention that is not based on operation by the occupant, the automobile 1 is expected to be able to achieve smooth and safe traveling even if an event occurs that is not foreseen by the occupant.

For example, for collision mitigation control, the AEBS apparatus 56 acquires detected information from one or more on-board sensors installed in the automobile 1, as information indicating a traveling state of the automobile 1, and generates a predicted course of the automobile 1. A predicted course 10 in FIG. 1 is a course running in a straight line along the straight road. A predicted course 10 in FIG. 2 is a course running along the bent curve of the road while changing a traveling direction. Moreover, the AEBS apparatus 56 generates a vehicle-width area along the predicted course 10 as an interference range 11, and predicts and determines interference with an obstacle to traveling, based on the interference range 11. When it is determined that interference will occur with an obstacle to traveling, the control system 50 causes the braking device 61 of the automobile 1 to operate and causes the automobile 1 to decelerate or stop such that the interference with the obstacle to traveling is prevented.

However, it is not easy for the AEBS apparatus 56 to generate the predicted course 10 that has no deviation from an actual course on which the automobile 1 will actually travel.

The AEBS apparatus 56 predicts a course of the automobile 1 that is turning, generally by using a calculation starting-point position, which is, for example, the position of the center of gravity or the position of the neutral steer point of the automobile 1 in a case where it is assumed that the automobile 1 travels through steady-state circular turning from the calculation starting-point position. Moreover, the AEBS apparatus 56 determines the interference range 11, which is an area passed when the automobile 1 travels according to the predicted course 10, based on the vehicle width of the automobile 1.

Under such prediction of the course and the interference range 11, for example, when the automobile 1 is traveling on a straight road at stable speed as in FIG. 1, it is possible for the AEBS apparatus 56 to predict the straight predicted course 10 and the rectangular interference range 11 that are probable and are less likely to deviate from the actual course on which the automobile 1 will actually move.

In contrast, when the automobile 1 is traveling on a curve or the like while turning as in FIG. 2, it is not easy for the AEBS apparatus 56 to predict a course that is less likely to deviate from the actual course on which the automobile 1 will actually move. In particular, when the automobile 1 is traveling on a downhill curve or an uphill curve, not a curve on level ground, a deviation between the predicted course 10 and the actual course can tend to become large. A deviation between the predicted course 10 and the actual course can also tend to become large when acceleration or deceleration is performed during a turn.

In addition, in the example in FIG. 2, the interference range 11 of the turning automobile 1, which is predicted based on the predicted course 10 that is based on the steady-state circular turning with constant radius, deviates inward from the actual course and overlaps the pedestrian 2 who is inside the shoulder of the curved road. In such a case, the AEBS apparatus 56 determines that the pedestrian 2 standing on a side of the road in FIG. 2 will interfere with the predicted course 10 of the turning automobile 1. To suppress the interference with the pedestrian 2 in the shoulder, with whom the probability of interference is low for the actual course, the AEBS apparatus 56 executes a collision mitigation process. As described above, if the AEBS apparatus 56 predicts a course and an interference range 11 that greatly deviate from an actual course, there remains a possibility that interference with an obstacle to traveling is determined excessively or insufficiently. As a result, there can arise a possibility that the control system 50 of the automobile 1 with collision mitigation control functionality executes the collision mitigation process that is excessive or insufficient based on a determination that can be greatly excessive or insufficient compared to reality. In such a case, there can arise a possibility that smooth and safe traveling of the automobile 1 is hindered.

As described above, there is a demand for the control system 50 of the automobile 1 to enhance the accuracy of the predicted course 10 of the turning automobile 1 predicted by the AEBS apparatus 56. There is a demand for the control system 50 of the automobile 1 to generate a predicted course 10 that takes behavior of the automobile 1 into consideration, in real time during travel and with a good probability, and to determine the probable predicted course 10 and interference even during a turn, which involves road gradient, acceleration and deceleration of the automobile 1, changes in pose of the automobile 1, and the like.

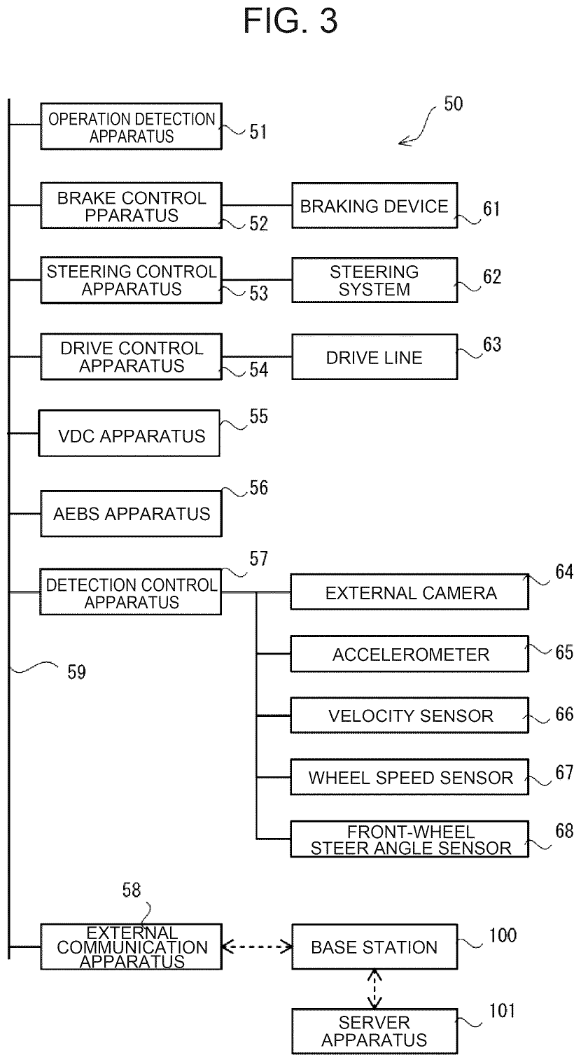

FIG. 3 is a basic configuration diagram of the control system 50 of the automobile 1 that serves as a vehicle collision mitigation apparatus according to the embodiment of the disclosure.

The control system 50 of the automobile 1 includes multiple control apparatuses for controlling traveling and the like of the automobile 1. In FIG. 3, an operation detection apparatus 51, a brake control apparatus 52, a steering control apparatus 53, a drive control apparatus 54, the VDC apparatus 55, the AEBS apparatus 56, a detection control apparatus 57, and an external communication apparatus 58 are illustrated as the control apparatuses provided in the control system 50. In addition, for example, an air-conditioning control apparatus, an occupant monitoring apparatus, an autonomous driving control apparatus, and the like may also be provided in the control system 50 of the automobile 1.

The control apparatuses provided in the control system 50 of the automobile 1 are coupled to a vehicle network 59. The vehicle network 59 may be a network that complies with a standard, such as controller area network (CAN) or local interconnect network (LIN). The vehicle network 59 may be a network that complies with a different standard than the above, such as Institute of Electrical and Electronics Engineers (IEEE) 802.3. The vehicle network 59 may be a network that complies with IEEE 802.15, or a combination of any of the networks. The control apparatuses can communicate information with each other through the vehicle network 59.

The operation detection apparatus 51 detects an operation performed by an occupant of the automobile 1 on an operation member, such as a steering wheel, an accelerator pedal, or a brake pedal, which are not depicted. Based on the detected operation by the occupant, the operation detection apparatus 51 generates traveling control information for controlling traveling of the automobile 1, and outputs the traveling control information to another control apparatus through the vehicle network 59.

The braking device 61 that generates braking force for decelerating and stopping the automobile 1 is coupled to the brake control apparatus 52. The brake control apparatus 52 acquires traveling control information from the operation detection apparatus 51 or the like and, based thereon, controls action of the braking device 61. Thus, the automobile 1 can decelerate and stop.

The steering system 62 that changes the directions of the front wheels, which are steered wheels of the automobile 1, is coupled to the steering control apparatus 53. The steering control apparatus 53 acquires traveling control information from the operation detection apparatus 51 or the like and, based thereon, controls action of the steering system 62. Thus, the automobile 1 can change the orientation thereof to the left or to the right and travel.

The drive line 63 that generates driving force for accelerating the automobile 1 is coupled to the drive control apparatus 54. The drive control apparatus 54 acquires traveling control information from the operation detection apparatus 51 or the like and, based thereon, controls action of the drive line 63. Thus, the automobile 1 can accelerate and maintain speed.

The on-board sensors provided in the automobile 1 are coupled to the detection control apparatus 57. Here, for the on-board sensors, an external camera 64, an accelerometer 65, a velocity sensor 66, a wheel speed sensor 67, and a front-wheel steer angle sensor 68 are illustrated. The on-board sensors detect traveling states of the automobile 1.

The external camera 64 is a camera that captures an image of an outside that is surroundings of the automobile 1. For example, the external camera 64 captures an image of the outside in front of the automobile 1, that is, in the traveling direction of the automobile 1. In the captured image of the outside in front of the automobile 1, an image of an obstacle to traveling, such as a leading vehicle or a pedestrian 2, existing in the traveling direction of the automobile 1 can be captured.

The external camera 64 may be a monocular camera, or a stereo camera that is capable of detecting a relative distance and a direction to the obstacle to traveling with high accuracy based on parallax. Note that with an image captured by a monocular camera, it is also possible to detect a relative distance and a direction to the obstacle to traveling, based on the positions of images of objects in the image.

The detection control apparatus 57 may extract the image-captured obstacle to traveling by analyzing the captured image, and may generate information on an attribute of the obstacle to traveling determined based on a feature of the image of the obstacle to traveling, as well as information on the relative distance, the direction, and the like.

The accelerometer 65 detects an acceleration rate of the automobile 1. Velocity can be obtained by time integration of the acceleration rates. The accelerometer 65 may be an accelerometer that can detect acceleration rates in three-axis directions.

For example, based on detected values from the accelerometer 65 that can detect acceleration rates in three-axis directions, the detection control apparatus 57 may calculate respective acceleration rates in yaw, pitch, and roll directions of the automobile 1, and further a yaw rate, a pitch rate, and a roll rate obtained by time integration of the acceleration rates in the yaw, pitch, and roll directions, respectively.

The velocity sensor 66 detects a traveling velocity at which the automobile 1 is actually moving. The detection control apparatus 57 may calculate a distance traveled when the automobile 1 moves, for example, at the traveling velocity from the velocity sensor 66.

The wheel speed sensor 67 detects a wheel speed that is the rotation speed of each of multiple wheels provided in the automobile 1. Wheels driven by the drive line 63 of the automobile 1 are rotationally driven while slipping with respect to a road surface. Wheels that are not driven, such as steered wheels, rotate by following the movement of the automobile 1 that moves due to the rotation of the drive wheels. As described above, each of the wheels provided in the automobile 1 rotates at each independent wheel speed. The speed at which each wheel rotates does not necessarily coincide with a velocity at which the automobile 1 moves.

The detection control apparatus 57 may calculate, for example, an average wheel speed of the wheels provided in the automobile 1.

The front-wheel steer angle sensor 68 detects the directions of the front wheels, which are the steered wheels provided in the automobile 1, as steer angles. The steer angle may be an angle indicating the direction of the corresponding steered wheel, relative to an angle made when the automobile 1 moves straight. The steer angles of the steered wheels of the automobile 1 that is turning do not necessarily coincide with a direction in which the automobile 1 actually moves.

The detection control apparatus 57 may calculate, for example, an average steer angle of the steered wheels provided in the automobile 1. The steer angle and the wheel speed of a steered wheel indicate a wheel speed vector of the steered wheel.

Then, the detection control apparatus 57 outputs the detected values from the on-board sensors, or the information generated based thereon, to another control apparatus through the vehicle network 59.

For example, the VDC apparatus 55 may acquire, from the detection control apparatus 57, detected information from the accelerometer 65, detected information from the velocity sensor 66, and information based on the detection, as information on behavior of the automobile 1 during travel. Then, when it is determined, based on the acquired information on behavior, that the automobile 1 is slipping, for example, while traveling on a curve or the like, the VDC apparatus 55 intervenes in traveling control of the automobile 1 and controls the drive line 63 and the braking device 61 of the automobile 1.

At the time, the VDC apparatus 55 may generate a yaw rate, a forward velocity, a centripetal lateral velocity, and the like of the automobile 1. For example, the VDC apparatus 55 may calculate the actual yaw rate at the central position of the wheels provided in the automobile 1. The VDC apparatus 55 may calculate the forward velocity at which the automobile 1 in the current traveling state seeks to move in a front-rear direction thereof, the centripetal lateral velocity at which the automobile 1 in the current traveling state seeks to move in a lateral direction thereof, and the like.

Moreover, the AEBS apparatus 56 may acquire, from the detection control apparatus 57, for example, the average wheel speed of the wheels provided in the automobile 1 and the information on the actual yaw rate, the forward velocity, the centripetal lateral velocity of the automobile 1, as information on behavior of the automobile 1 during travel. The AEBS apparatus 56 may acquire such information from the VDC apparatus 55 or the like, not from the detection control apparatus 57. Then, when it is determined, based on the acquired information on behavior, that interference can occur with an obstacle to traveling, the AEBS apparatus 56 intervenes in traveling control of the automobile 1 and controls the braking device 61 and the steering system 62 of the automobile 1.

The external communication apparatus 58 establishes a wireless communication channel with a base station 100 and communicates information with a server apparatus 101 coupled to the base station 100.

Base stations 100 include, for example, a base station installed by a carrier that provides a mobile communication network, a base station installed to provide road traffic information, and the like. Base stations installed by carriers include, for example, a 5G base station that is capable of high-speed and large-capacity communication. Such 5G base stations may be installed, for example, in a line along a road traveled by the automobile 1 or the like.

Server apparatuses 101 include, for example, a server apparatus for advanced driver assistance systems (ADAS), a server apparatus provided by the manufacturer of the automobile 1, a server apparatus for emergency, and the like. The external communication apparatus 58 may communicate information with such server apparatuses 101 according to needs. Note that some base stations 100 have advanced calculation functionality. In such a case, the server apparatuses 101 may be mounted in multiple base stations 100 in a distributed manner.

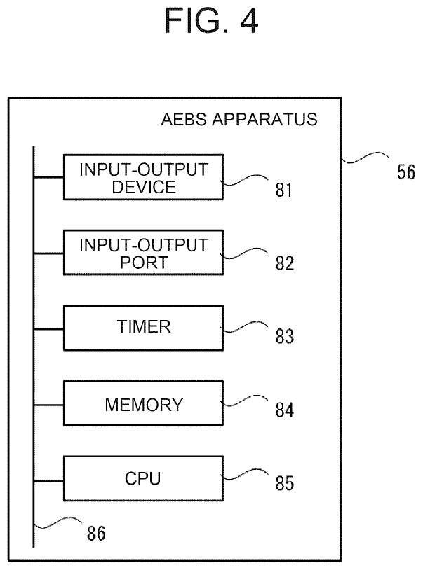

FIG. 4 is a basic configuration diagram of the AEBS apparatus 56 that performs collision mitigation control in FIG. 3.

The AEBS apparatus 56 in FIG. 4 includes an input-output device 81, an input-output port 82, a timer 83, a memory 84, a central processing unit (CPU) 85, and an internal bus 86 to which these components are coupled.

Note that the other control apparatuses in FIG. 3 may have basic configurations similar to FIG. 4.

The input-output device 81 is coupled to the vehicle network 59 and receives information from and outputs information to another control apparatus through the vehicle network 59.

Various apparatuses or devices to be coupled to the AEBS apparatus 56 are coupled to the input-output port 82. For example, the braking device 61 and the steering system 62 in FIG. 3 may be directly coupled to the input-output port 82 of the AEBS apparatus 56.

The timer 83 measures time of day, an elapsed time, or the like.

A program to be executed by the CPU 85 and various kinds of information are recorded on the memory 84. Various kinds of information acquired from another control apparatus may be recorded on the memory 84.

The CPU 85 reads and executes the program recorded on the memory 84. Thus, a controller that controls action of the AEBS apparatus 56 is implemented on the AEBS apparatus 56.

Then, the CPU 85 of the AEBS apparatus 56, as a controller, may acquire information based on detection by the one or more on-board sensors, and may execute the collision mitigation process of causing one or both of the braking device 61 and the steering system 62 of the automobile 1 to operate.

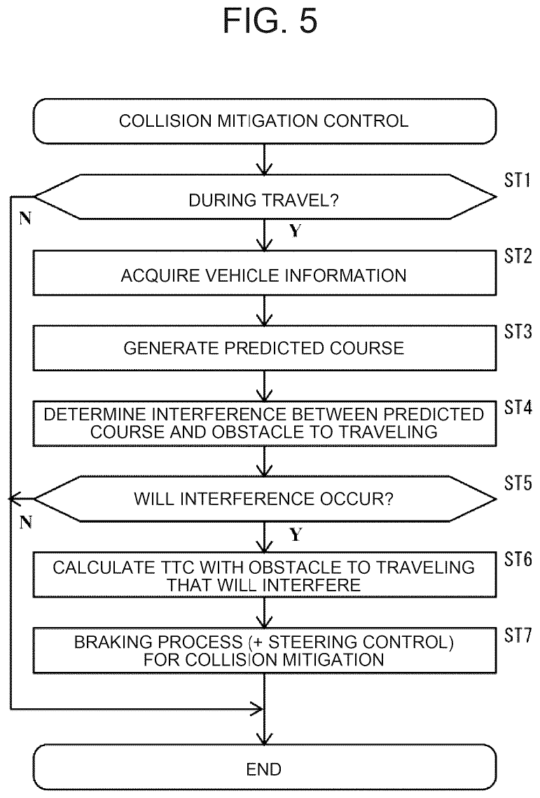

FIG. 5 is a flowchart illustrating a basic flow of the collision mitigation control that is executed by the CPU 85 of the AEBS apparatus 56 in FIG. 4.

The CPU 85 of the AEBS apparatus 56 performs the collision mitigation control in FIG. 5 repeatedly, for example, while the automobile 1 is traveling.

Note that the collision mitigation control in FIG. 5 may be performed by the CPU 85 of a control apparatus, other than the AEBS apparatus 56, that is provided basically in the control system 50.

The collision mitigation control in FIG. 5 may be performed in cooperation by the CPUs 85 of multiple control apparatuses that are provided basically in the control system 50.

In step ST1, the CPU 85 determines whether the automobile 1 is traveling. The automobile 1 being traveling may be a state in which the automobile 1 is traveling at a speed that is more than zero km/h. The velocity sensor 66 detects a traveling velocity at which the automobile 1 is actually moving. When the automobile 1 is traveling, the CPU 85 advances the process to step ST2. When the automobile 1 is not traveling, the CPU 85 terminates the present control, without executing the collision mitigation process in step ST7.

In step ST2, the CPU 85 acquires various kinds of detected information detected on the automobile 1. The CPU 85 may store in advance information acquired beforehand from the detection control apparatus 57, the VDC apparatus 55, and the like on the memory 84, and may acquire the detected information from the memory 84 in step ST2. The detected information acquired here may basically include, for example, a wheel speed, a steer angle, an actual yaw rate indicating a behavior actually occurring in the automobile 1, a velocity and a traveling direction of the automobile 1, an image captured by the external camera 64, and the like.

In step ST3, the CPU 85 generates a predicted course 10 along which the automobile 1 is expected to travel in the future in a traveling state that can be determined based on the detected information acquired in step ST2.

In step ST4, the CPU 85 predicts and determines interference between the predicted course 10 and an obstacle to traveling. The CPU 85 may generate attribute information, such as a type, a relative distance, and a relative direction, on obstacles to traveling existing in a traveling direction of the automobile 1 and around the traveling direction, through pattern matching determination for each type of obstacle to traveling, or artificial intelligence (AI) determination based on machine learning, performed with regard to the captured image. Moreover, with regard to the predicted course 10, the CPU 85 generates an area of the vehicle width of the automobile 1, or the area of the vehicle width plus a margin, as an interference range 11. Then, when the obstacle to traveling overlaps the interference range 11, the CPU 85 may determine that interference will occur. When the obstacle to traveling does not overlap the interference range 11, the CPU 85 may determine that interference will not occur.

In step ST5, the CPU 85 determines whether it is determined, based on the predicted course 10, that interference will occur with regard to at least one obstacle to traveling. When there is no obstacle to traveling with regard to which it is determined that interference will occur, the present control is terminated, without the collision mitigation process in step ST7 being executed. When there is at least one obstacle to traveling with regard to which it is determined that interference will occur, the process is advanced to step ST6. When it is not determined that interference will occur, the CPU 85 terminates the present control, without executing the collision mitigation process. When it is not predicted or determined that interference will occur with an obstacle to traveling, the CPU 85 does not execute the collision mitigation process of causing the braking device 61 to operate.

In step ST6, the CPU 85 calculates a time to collision (TTC) with the obstacle to traveling with which interference is predicted. The CPU 85 may calculate the TTC, for example, through calculation that divides the relative distance to the obstacle to traveling by the latest velocity of the automobile 1. When it is predicted that interference will occur with multiple obstacles to traveling, the CPU 85 may calculate the TTC with regard to each obstacle to traveling.

In step ST7, the CPU 85 executes the collision mitigation process that intervenes in traveling control at normal times, which is based on operation by an occupant or the like. The CPU 85 causes the braking device 61 to operate in such a manner that a stop is made within the period of the least TTC calculated in step ST6. Thus, the CPU 85 can achieve such deceleration as to make a stop within the period of the least TTC. When the overlap ratio with the obstacle to traveling is equal to or less than a predetermined value, the CPU 85 may execute the collision mitigation process that involves steering, by causing the steering system 62 together with the braking device 61 to operate. Thereafter, the CPU 85 terminates the present control.

Through such control, the CPU 85 of the AEBS apparatus 56 can perform intervening control for mitigating predicted collision, for the automobile 1 that is traveling. Next, the control in the present embodiment by the CPU 85 of the AEBS apparatus 56 is described in detail by taking a case where the automobile 1 is turning as an example.

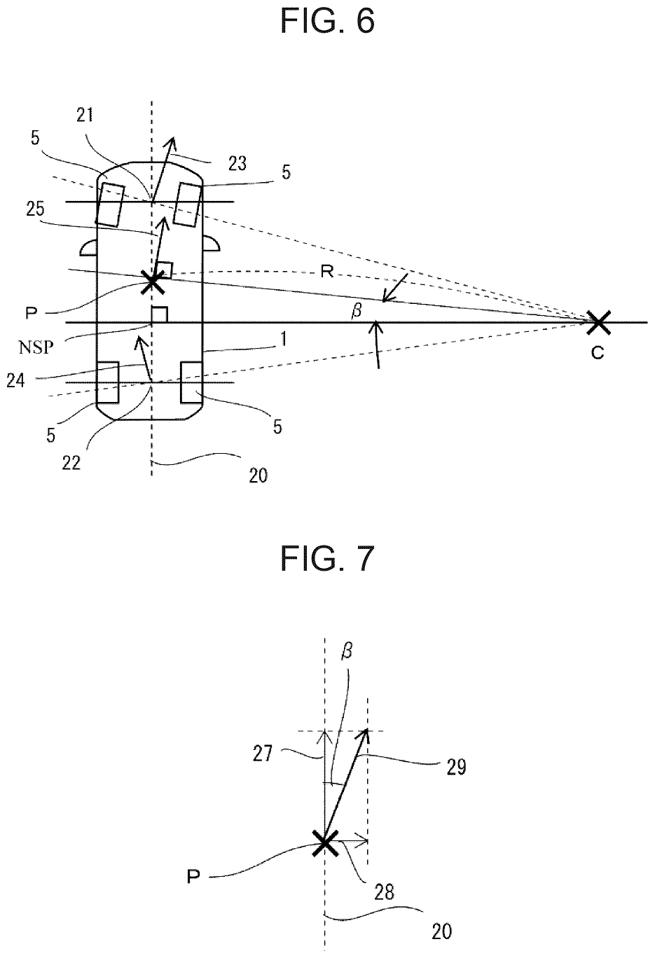

FIG. 6 is an explanatory diagram regarding various geometric matters of the automobile 1 that is turning.

In FIG. 6, the automobile 1 that has the multiple wheels on the front and the rear and on the right and the left is illustrated as the automobile 1 that is turning. A right front wheel 5 and a left front wheel 5 are steered wheels, the directions of which can be changed by the steering system 62. A right rear wheel 5 and a left rear wheel 5 are drive wheels, which are driven mainly by the drive line 63. Note that in a four-wheel-drive automobile 1, the right front wheel 5 and the left front wheel 5 can also be driven by the drive line 63.

In the automobile 1, a longitudinal section 20 in the middle in a vehicle-width direction of the automobile 1 can be defined in such a manner as to divide the automobile 1 in the middle in the vehicle-width direction. The longitudinal section 20 in the middle in the vehicle-width direction extends in the front-rear direction of the automobile 1. The center of gravity and the neutral steer point (NSP) of the automobile 1 exist on the longitudinal section 20 in the middle in the vehicle-width direction. Basic turning characteristics of the automobile 1 are determined by a front-rear relationship between the position of the center of gravity and the position of the NSP.

When such an automobile 1 turns, a course of the automobile 1 that is turning can be thought of, in an approximated manner, as a course for a steady-state circular turn basically with a constant radius R of rotation. In a case of the example in FIG. 6, a center C of the turn can be thought to exist in a direction perpendicular to the longitudinal section 20 in the middle in the vehicle-width direction, from the position of the NSP. The steady-state circular turn described in FIG. 2 is used to calculate the predicted course 10 of the turning automobile 1, based on the assumption as described above.

FIG. 7 is a geometric explanatory diagram of a method of calculating a sideslip angle β.

In FIG. 7, a central position P of the four wheels 5 of the automobile 1 is illustrated. Moreover, as force acting on the central position P of the four wheels 5, an actual moving velocity vector 29, a centripetal lateral velocity vector 28, and a forward velocity vector 27 are illustrated.

The centripetal lateral velocity vector 28 is a velocity vector indicating a velocity at which the automobile 1 moves in a direction perpendicular to the longitudinal section 20 in the middle in the vehicle-width direction. Such a centripetal lateral velocity vector 28 is a velocity vector in a direction toward the center C of the turn that acts on the automobile 1 that is turning.

The forward velocity vector 27 is a velocity vector indicating a velocity at which the automobile 1 moves in a direction of the longitudinal section 20 in the middle in the vehicle-width direction. Such a forward velocity vector 27 is a velocity vector in the front-rear direction that acts on the automobile 1 that is turning.

As described above, the forward velocity vector 27 and the centripetal lateral velocity vector 28 are orthogonal at the central position P of the four wheels 5.

The centripetal lateral velocity vector 28 and the forward velocity vector 27 are velocities in the respective directions in which the automobile 1 moves, including components caused by behaviors actually occurring in the automobile 1 that is turning.

The centripetal lateral velocity vector 28 and the forward velocity vector 27 can be calculated based on detected values from the accelerometer 65 by time integral thereof in each predetermined direction. The VDC apparatus 55 calculates the centripetal lateral velocity vector 28 and the forward velocity vector 27, in order to perform control basically at the VDC apparatus 55.

Then, through trigonometric calculation using such forward velocity vector 27 and centripetal lateral velocity vector 28 that are orthogonal, it is possible to calculate the actual moving velocity vector 29 indicating a direction in which the central position P of the four wheels 5 of the automobile 1 seeks to move.

Moreover, through trigonometric calculation using the forward velocity vector 27 and the centripetal lateral velocity vector 28 that are orthogonal, the sideslip angle β can be calculated that is an angle made by the actual moving velocity vector 29 with the longitudinal section 20 in the middle in the vehicle-width direction.

Incidentally, in the automobile 1 that is turning, a front-wheel-side middle position 21 between the right front wheel 5 and the left front wheel 5 exists on the longitudinal section 20 in the middle in the vehicle-width direction, as illustrated in FIG. 6. When the automobile 1 is turning, it is possible to think that the front-wheel-side middle position 21 between the right front wheel 5 and the left front wheel 5 seeks to move in a direction according to steering at an average wheel speed of the right front wheel 5 and the left front wheel 5, as indicated as a front-wheel-side wheel speed vector 23 in FIG. 6.

Moreover, in the automobile 1 that is turning, a rear-wheel-side middle position 22 between the right rear wheel 5 and the left rear wheel 5 exists on the longitudinal section 20 in the middle in the vehicle-width direction. When the automobile 1 is turning, it is possible to think that the rear-wheel-side middle position 22 between the right rear wheel 5 and the left rear wheel 5 seeks to move in an opposite direction to the steering at an average wheel speed of the right rear wheel 5 and the left rear wheel 5, as indicated as a rear-wheel-side wheel speed vector 24 in FIG. 6.

Then, it is possible to think that the automobile 1 is moving while turning due to resultant force of the front-wheel-side wheel speed vector 23 and the rear-wheel-side wheel speed vector 24. In such a case, it is possible to think that, for example as illustrated in FIG. 6, the automobile 1 seeks to move in the direction of a resultant vector 25 that is a vector of the resultant force, from the central position P of the four wheels 5 provided in the automobile 1. The resultant vector 25 represents the resultant force of the front-wheel-side wheel speed vector 23 and the rear-wheel-side wheel speed vector 24 of the automobile 1 that is traveling while sideslipping, and includes a sideslip component.

However, it is difficult to calculate the front-wheel-side wheel speed vector 23 and the rear-wheel-side wheel speed vector 24 as described above, based on detection by the on-board sensors provided in the automobile 1. Even if a wheel speed and a steer angle of each wheel 5 are detected, it is difficult, only from the wheel speeds and the steer angles, to obtain, with a good probability, particularly the rear-wheel-side wheel speed vector 24 and the like, which are of the wheels that, for example, deform or slip with respect to a road surface during a turn. As a result, it is very difficult to calculate the resultant vector 25, based on the front-wheel-side wheel speed vector 23 and the rear-wheel-side wheel speed vector 24.

Accordingly, in the present embodiment, attention is focused on the fact that the resultant vector 25 that makes the automobile 1 move has a certain angle with the longitudinal section 20 in the middle in the vehicle-width direction of the automobile 1 at the central position P of the four wheels 5 of the automobile 1. Moreover, attention is focused on it being possible to assume that the angle made by the resultant vector 25 with the longitudinal section 20 in the middle in the vehicle-width direction is approximately equal to the angle β made by the actual moving velocity vector 29 with the longitudinal section 20 in the middle in the vehicle-width direction in FIG. 7. As described above, it can be said that the actual moving velocity vector 29 in FIG. 7 has a well corresponding relationship with the resultant vector 25 in FIG. 6.

In such a case, the angle β made by the actual moving velocity vector 29, which can be calculated based on FIG. 7, with the longitudinal section 20 in the middle in the vehicle-width direction can be used for the angle (sideslip angle) made by the resultant vector 25 with the longitudinal section 20 in the middle in the vehicle-width direction in FIG. 6.

Moreover, in the automobile 1 that is turning, an angle made by a segment between the central position P of the four wheels 5 and the center C of a turn and a segment between the position of the NSP and the center C of a turn in FIG. 6 is also the sideslip angle 3.

The present embodiment is to calculate the predicted course 10 of the turning automobile 1 and further calculate the interference range 11 based on the predicted course 10, based on such relationships that the inventors of the disclosure have uniquely found based on earnest efforts.

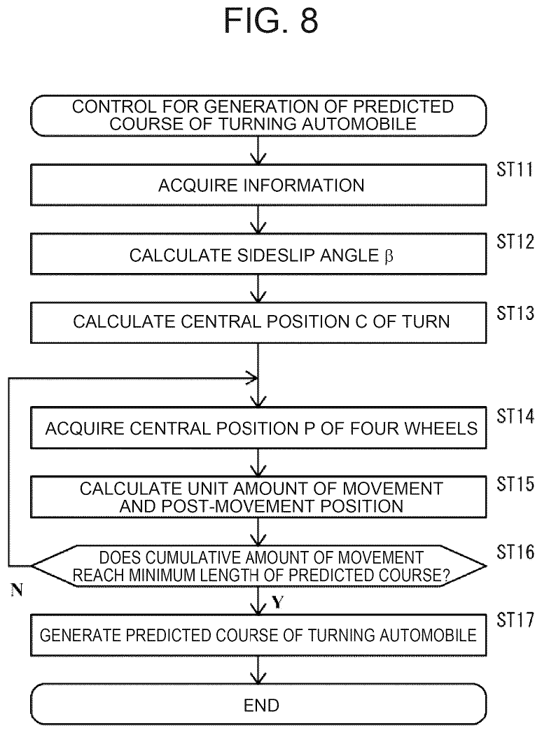

FIG. 8 is a flowchart of control for generation of the predicted course 10 of the turning automobile 1 in the present embodiment.

For example, as the processes in steps ST2 to ST3 in FIG. 5, the CPU 85 of the AEBS apparatus 56 may repeatedly perform the control for generation of the predicted course 10 of the turning automobile 1 in FIG. 8 while the automobile 1 is traveling while turning.

Note that a description below uses a case, as an example, where the automobile 1 is turning, and it is possible to perform the control for generation of the predicted course 10 of the turning automobile 1 in FIG. 8 even when the automobile 1 is moving straight. In such a case, for example, zero degrees may be used for the sideslip angle 3.

In step ST11, the CPU 85 acquires information for the control for generation of the predicted course 10 of the turning automobile 1. Here, for example, as detection by the on-board sensors or information based on the detection, the centripetal lateral velocity vector 28 and the forward velocity vector 27 at the central position P of the four wheels 5 of the automobile 1 and an actual yaw rate are acquired.

In step ST12, the CPU 85 calculates the sideslip angle β of the automobile 1 that is turning. The CPU 85 calculates the sideslip angle β, based on the relationship in FIG. 7, through trigonometric calculation using the centripetal lateral velocity vector 28 and the forward velocity vector 27.

Note that when it is possible to acquire wheel speeds of the four wheels 5 from on-board sensors, the CPU 85 may acquire the actual moving velocity vector 29, from an average value of the wheel speeds and steer angles of the four wheels 5. In such a case, the CPU 85 can calculate the sideslip angle β through trigonometric calculation using the actual moving velocity vector 29 and, for example, the centripetal lateral velocity vector 28.

In step ST13, the CPU 85 calculates the central position C of a turn of the automobile 1 that is turning. The CPU 85 calculate the central position C of a turn that is located in a direction perpendicular to the actual moving velocity vector 29, with the actual moving velocity vector 29 as the resultant vector at the central position P of the four wheels 5 of the automobile 1 in FIG. 6 serving as a reference. The CPU 85 obtains a radius of the turn by dividing the magnitude of an actual moving velocity by the actual yaw rate at the central position P of the four wheels 5. Moreover, the CPU 85 sets a position that is the radius of the turn away from the central position P of the four wheels 5 in the above-mentioned perpendicular direction, as the central position C of a turn.

In step ST14, the CPU 85 acquires the central position P of the four wheels 5 as a calculation starting-point position.

By acquiring the central position P of the four wheels 5 as a calculation starting-point position, the CPU 85 can set the calculation starting-point position at a position that is close to an actual center C of a turn.

Note that apart from the central position P of the four wheels 5, it is possible to use, for example, the position of the NSP of the automobile 1 or the position of the center of gravity of the automobile 1 for the calculation starting-point position. However, the central position P of the four wheels 5 is a closer position to the actual center C of a turn, compared to the position of the NSP and the position of the center of gravity of the automobile 1, and may dynamically change.

In step ST15, the CPU 85 calculates an amount of movement (a unit amount of movement) in a unit time, in the direction of the actual moving velocity vector 29 from the calculation starting-point position, and further calculates a post-movement position thereafter. Thus, the CPU 85 can calculate the position to which movement is made in the unit time from the calculation starting-point position.

At the time, the CPU 85 may calculate the unit amount of movement and the post-movement position in a case where it is assumed that the central position P of the four wheels 5 of the automobile 1 makes a steady-state circular turn about the center C of rotation of the turn, with a radius R of a turn that is the distance between the central position P and the center C of rotation. A certain degree of accuracy can be expected of the unit amount of movement and the post-movement position based on the assumption of a steady-state circular turn with such a radius of a turn and in a very short period of time. However, in such a case, since a sideslipping behavior of the automobile 1 is not considered in the very direction in which the automobile 1 moves, it is highly probable that the accuracy of the unit amount of movement and the post-movement position obtained as a result is lower than when the actual moving velocity vector 29 is used.

In step ST16, the CPU 85 determines whether the cumulative amount of movement of all of the one or more unit amounts of movement obtained through the hitherto calculation reaches a minimum length that is to be obtained as the predicted course 10. When the cumulative amount of movement does not reach the minimum length of the predicted course 10, the CPU 85 returns the process to step ST14. The CPU 85 sets the post-movement position calculated in step ST15 as a new calculation starting-point position and repeats the processes in steps ST14 to ST16. When the cumulative amount of movement becomes the minimum length of the predicted course 10 or more and it is determined that the minimum length is reached, the CPU 85 advances the process to step ST17. As described above, in order to obtain the predicted course 10 with a desired length, the CPU 85 repeatedly calculates a unit amount of movement in each unit time and joins the unit amounts of movement together.

In step ST17, the CPU 85 generates the predicted course 10 with a desired length by joining the unit amount of movement in each unit time together.

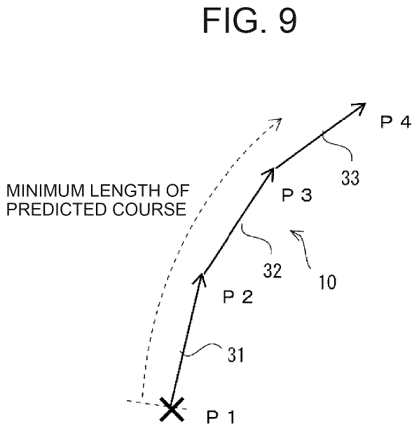

FIG. 9 is an explanatory diagram of an example of the predicted course 10 of the turning automobile 1 in the present embodiment.

For the predicted course 10 of the turning automobile 1 in FIG. 9, the CPU 85 generates the predicted course 10 with a desired length by repeating the processes in steps ST14 to ST16 in FIG. 8 three times and calculating a first unit amount of movement 31, a second unit amount of movement 32, and a third unit amount of movement 33.

The first unit amount of movement 31 is for a segment starting from an initial calculation starting-point position P1 toward a second calculation starting-point position P2.

The second unit amount of movement 32 is for a segment starting from the second calculation starting-point position P2 toward a third calculation starting-point position P3.

The third unit amount of movement 33 is for a segment starting from the third calculation starting-point position P3 toward a fourth calculation starting-point position P4.

The predicted course 10 of the turning automobile 1 in FIG. 9 is a course starting from the initial calculation starting-point position P1 toward the fourth calculation starting-point position P4 via the second calculation starting-point position P2 and the third calculation starting-point position P3.

As described above, the CPU 85 generates the predicted course 10 of the turning automobile 1, with a desired length, by repeatedly calculating a post-movement position based on the unit time or the unit amount of movement in a case where it is assumed that the automobile 1 that is turning makes a steady-state circular turn about the central position C of the turn with the radius R of the turn, in the direction of an actual moving velocity.

Note that the very short period of time corresponding to each segment may be basically any very short period of time. However, as the very short period of time is made smaller, a processing load on the CPU 85 increases, although the accuracy of the amount of movement and the post-movement position that are obtained is enhanced.

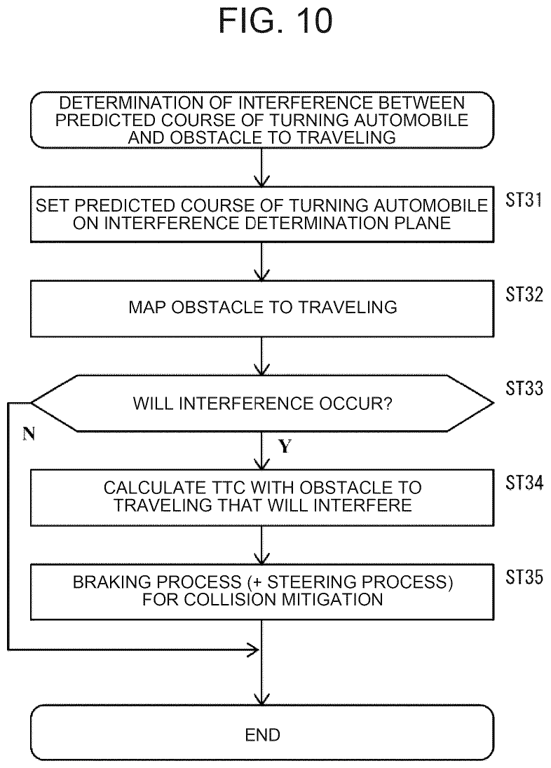

FIG. 10 is a flowchart of control for determination of interference between the predicted course 10 of the turning automobile 1 and an obstacle to traveling in the present embodiment.

For example, as the processes in steps ST4 to ST5 in FIG. 5, the CPU 85 of the AEBS apparatus 56 may repeatedly perform the control for determination of interference between the predicted course 10 of the turning automobile 1 and an obstacle to traveling in FIG. 10 when the automobile 1 is traveling while turning.

Note that a description below uses a case, as an example, where the automobile 1 is turning, and it is possible to perform the control for determination of interference with an obstacle to traveling in FIG. 10 even when the automobile 1 is moving straight.

In step ST31, the CPU 85 sets the predicted course 10 of the turning automobile 1 generated in FIG. 9 on an interference determination plane 70. The predicted course 10 of the turning automobile 1 is a bent predicted course 10 as illustrated in FIG. 9. In such a case, the bent predicted course 10 may be unbent into a straight shape and set on a vertical axis of the interference determination plane 70. The interference determination plane 70 is a plane indicating a range of movement when the automobile 1 is assumed to move in a current traveling state.

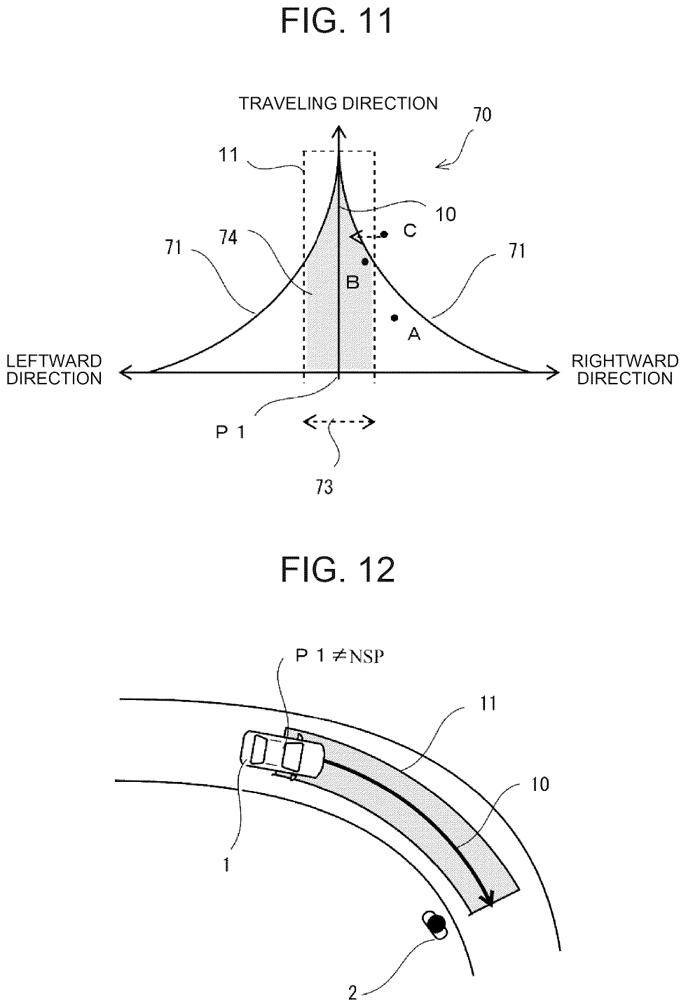

FIG. 11 is an explanatory diagram of an example of the interference determination plane 70 corresponding to the predicted course 10 of the turning automobile 1, which is used in the determination of interference.

The origin of the interference determination plane 70 in FIG. 11 is a central position P1 of the four wheels 5 that is calculated first in the generation of the predicted course 10 of the turning automobile 1. The vertical axis may represent distances from the central position P1 in a traveling direction. In such a case, the bent predicted course 10 is unbent into a straight shape and then set on the interference determination plane 70. A horizontal axis represents positions from the central position P1 of the four wheels 5 in lateral directions.

In addition, a stopping distance curve 71 made by the AEBS apparatus 56 according to the braking performance, the current velocity, and the like of the automobile 1 is preset on the interference determination plane 70 in such a manner as to be symmetrical with respect to the vertical axis. The automobile 1 can stop at positions on the stopping distance curve 71 through the intervening control by the AEBS apparatus 56.

The automobile 1 has a vehicle width. Accordingly, the interference range 11 is set in the interference determination plane 70, on an area corresponding to the vehicle width with the midpoint of the vehicle width set on the vertical axis. Note that the width of the interference range 11 may include a margin added to the vehicle with of the automobile 1. The margin may be increased or decreased, according to a traveling environment for the automobile 1 or the like. Here, it is assumed that an area where hatching is applied in the drawing is set as the interference range 11. Note that the interference range 11 may be a rectangular area indicated by a dotted line.

As described above, the interference range 11 in a case where it is assumed that the automobile 1 travels along the predicted course 10 of the turning automobile 1 at an actual moving velocity is set in the interference determination plane 70.

Note that although the automobile 1 makes a sideslip during a turn, the sideslip has been already taken into consideration in the calculation of the predicted course 10. Accordingly, it is not necessary to add a margin corresponding to the sideslip of the automobile 1 to the width or the length of the interference range 11. Thus, it is possible to restrain the interference range 11 from becoming excessive due to various margins, to achieve determination of probable interference by using the interference range 11 of an appropriate size, and to contribute to smooth and safe traveling of the automobile 1.

In addition, as a result of the probability of the predicted course 10 of the turning automobile 1 compared to an actual course increasing, the automobile 1 will move basically along the predicted course 10 of the turning automobile 1. Accordingly, it is also possible to limit the interference range 11 to the vehicle width of the automobile 1. Based on the interference range 11 limited to the vehicle width of the automobile 1, the CPU 85 may determine that an obstacle to traveling existing in the interference range 11 and an obstacle to traveling moving into the interference range 11 will interfere.

In step ST32, the CPU 85 maps an obstacle to traveling existing around the automobile 1 onto the interference determination plane 70.

For example, in step ST2 in FIG. 5, the CPU 85 may acquire an image captured by the external camera 64. In such a case, the CPU 85 may extract the obstacle to traveling existing around the automobile 1 by analyzing the captured image. Moreover, for each extracted obstacle to traveling, the CPU 85 may generate information on the relative distance and direction from the automobile 1. The CPU 85 maps each extracted obstacle to traveling onto the interference determination plane 70 in such a manner as to place the obstacle to traveling at the relative position.

A position of mapping an obstacle to traveling in the horizontal-axis direction may be, for example, the shortest distance from the predicted course 10 of the turning automobile 1. A position of mapping the obstacle to traveling in the vertical-axis direction may be a position corresponding to the shortest distance on the predicted course 10 of the turning automobile 1.

In step ST33, the CPU 85 determines, based on the interference determination plane 70 on which the obstacle to traveling is mapped, whether interference will occur with the obstacle to traveling when the automobile 1 is assumed to move along the predicted course 10 of the turning automobile 1. The CPU 85 predicts and determines interference with each obstacle to traveling, based on the mapping of the position and a moving direction of the obstacle to traveling on the generated interference determination plane 70. When any one obstacle to traveling exists with which it is determined that interference will occur, the CPU 85 advances the process to step ST34. When any one obstacle to traveling does not exist with which it is determined that interference will occur, the CPU 85 terminates the present control, without executing the collision mitigation process.

In step ST34, the CPU 85 calculates a time period before interference occurs with the obstacle to traveling that is supposed to interfere, by using a time to collision (TTC). When multiple obstacles to traveling exist that are supposed to interfere, the CPU 85 calculates a TTC with regard to each obstacle to traveling.

In step ST35, the CPU 85 causes the braking device 61 to operate and performs brake control for collision mitigation to stop the automobile 1 before the TTC passes. When it is impossible to stop the automobile 1 before the TTC passes, the CPU 85 may cause the steering system 62 to operate together with the braking device 61 and may perform steering control to avoid interference with the obstacle to traveling at the same time. When the TTCs are calculated with regard to multiple obstacles to traveling, the CPU 85 may perform such controls to mitigate collision, based on the least TTC. Moreover, at a timing of executing the collision mitigation processes, time has passed since step ST2. The CPU 85 may perform the brake control that takes the delay in control into consideration. Thereafter, the CPU 85 terminates the present control.

As described above, when it is predicted and determined that interference will occur with an obstacle to traveling, the CPU 85 of the AEBS apparatus 56 executes the collision mitigation process of causing one or both of the braking device 61 and the steering system 62 to operate. In contrast, when it is not predicted or determined that interference will occur with an obstacle to traveling, the CPU 85 does not execute the collision mitigation process.

For example, a first obstacle to traveling A, a second obstacle to traveling B, and a third obstacle to traveling C are mapped on the interference determination plane 70 in FIG. 11.

In such a case, for the first obstacle to traveling A and the third obstacle to traveling C that do not exist in the interference range 11, the CPU 85 may determine that interference will not occur.

In contrast, for the second obstacle to traveling B that exists in the interference range 11, it is determined that interference will occur. In such a case, the CPU 85 calculates a TTC with regard to the second obstacle to traveling B and performs traveling control for preventing the interference with the second obstacle to traveling B.

Note that in FIG. 11, the third obstacle to traveling C that does not exist in the interference range 11 is moving in such a manner as to approach the interference range 11. In such a case, also for the third obstacle to traveling C, the CPU 85 may determine that interference will occur. In such a case, the CPU 85 calculates a TTC with regard to the second obstacle to traveling B and calculates a TTC also with regard to the third obstacle to traveling C. Then, based on the least TTC with regard to the second obstacle to traveling B, the CPU 85 performs traveling control for preventing the interference with the second obstacle to traveling B.

FIG. 12 is an explanatory diagram of a state in which the automobile 1 is traveling on a bent curve of a road under control in the present embodiment, and an example of the collision mitigation control in such a case.

FIG. 12 corresponds to FIG. 2.

The predicted course 10 of the turning automobile 1 in FIG. 12 is bent well along an actual road, compared to the predicted course 10 based on a steady-state circular turn in FIG. 2.

However, since behavior of the automobile 1 is considered based on the sideslip angle β of the automobile 1, the interference range 11 in FIG. 12, though bent, is set in such a manner as to fit in the actual road.

In such a case, unlike the case in FIG. 2, the interference range 11 does not overlap a pedestrian 2 existing inside the shoulder of the curved road. The CPU 85 of the AEBS apparatus 56 does not determine that the pedestrian 2 standing on a side of the road in FIG. 12 will interfere with the predicted course 10 of the turning automobile 1. The AEBS apparatus 56 can prevent smooth and save traveling of the automobile 1 from being hindered.

As described above, in the present embodiment, the predicted course 10 of the automobile 1 that is turning, which is used to predict and determine whether the automobile 1 that is turning will interfere with an obstacle to traveling, is generated through calculation using the sideslip angle β of the automobile 1 caused by the turn. In the present embodiment, the central position of the automobile 1 is set as a calculation starting-point position for the predicted course 10 of the turning automobile 1, and an amount of movement made by the automobile 1 making a turn from the calculation starting-point position and a post-movement position are calculated by using information based on detection by one or more on-board sensors, or an actual moving velocity of the automobile 1 that is turning oriented in the direction of the sideslip angle β of the automobile 1 that is turning, which can be calculated based on the detection-based information, whereby the predicted course 10 of the turning automobile 1 is calculated.

By performing the calculation by using the sideslip angle β of the automobile 1 caused by a turn as described above, the predicted course 10 of the turning automobile 1 is made to well correspond to an actual course along which the automobile 1 will actually turn, and it can be expected that a deviation from the actual course is reduced. As a result, according to the present embodiment, in determination of interference with an obstacle to traveling by using the predicted course 10 of the turning automobile 1, interference with the obstacle to traveling in a case where the automobile 1 actually turns along an actual course can be determined with a good probability, neither too excessively nor too insufficiently. In the present embodiment, it can be expected that accuracy in prediction of interference with an obstacle to traveling is increased, so that it is made more difficult to excessively determine, or insufficiently determine, interference with an obstacle to traveling.

In contrast, for example, if the position of the neutral steer point, the position of the center of gravity, or the like of the automobile 1 is used for a calculation starting-point position in prediction of a turning course, or when it is assumed that the automobile 1 moves by making a steady-state circular turn that follows a constant radius of the turn from a calculation starting-point position, it can be thought that the predicted course 10 generated in such cases does not take into consideration a body motion, such as a sideslip, that actually acts on the automobile 1 that is turning. As a result, the predicted course 10 of the turning automobile 1 that is predicted based on the above-mentioned position or turn tends to deviate greatly from an actual course. Although even such a predicted course 10 of the turning automobile 1 that does not take a body motion, such as a sideslip, into consideration can bring about certain utility, the possibility increases that an excessive or insufficient determination that does not fit reality is made, such as excessively determining interference with an obstacle to traveling that actually will not interfere, or insufficiently determining interference with an obstacle to traveling that actually will interfere. In particular, when a turn is made in a downhill or uphill curve that slopes, not a curve on level ground, or when acceleration or deceleration is performed during a turn, a large body motion tends to occur, and deviation tends to become large.

If the collision mitigation process is executed based on such determination that tends to be made too excessively or too insufficiently, the possibility increases that smooth and safe traveling of the automobile 1 is hindered. In the present embodiment, such possibility can be well reduced. In the present embodiment, a body motion occurring when a turn is made in a sloping curve can be supplemented with the calculation of the sideslip angle β, and a body motion occurring when acceleration or deceleration is performed during a turn can be supplemented with the calculation of the sideslip angle β, so that an excessive or insufficient determination is more difficult to make.

Further, in the present embodiment, good interference mitigation control can be implemented that is less excessive or insufficient with respect to reality, by obtaining, through simple real-time calculation as described above, the predicted course 10 of the turning automobile 1 that takes into consideration changes in pose of the automobile 1 due to the gradient of a road, steering during the turn, and the like.

Although the above embodiment is an example of embodiments to which the disclosure is applicable, the disclosure is not limited thereto, and various modifications and changes can be made within the scope that does not depart from the gist of the disclosure.

In the above-described embodiment, the control system 50 of the automobile 1 serves as a vehicle collision mitigation apparatus. In addition, for example, an undepicted CPU of the server apparatus 101 may perform the control in FIG. 5, FIG. 8, or FIG. 10, based on information acquired from the automobile 1. In such a case, the control system 50 of the automobile 1 may control traveling of the automobile 1, based on command information for collision mitigation that is generated by the server apparatus 101.

What is claimed is:

1. A vehicle collision mitigation apparatus configured to cause a braking device or a steering system of a vehicle to operate and mitigate collision of the vehicle, the vehicle collision mitigation apparatus comprising:
one or more on-board sensors provided in the vehicle, the one or more on-board sensors comprising an accelerometer configured to perform a detection of at least an acceleration rate of the vehicle as a traveling state of the vehicle; and
a controller configured to acquire information based on a detection by the one or more on-board sensors and execute a collision mitigation process of causing one or both of the braking device and the steering system of the vehicle to operate, wherein
the controller is configured to
set a central position of the vehicle as a calculation starting-point position for a predicted course of the vehicle that is turning,
generate the predicted course of the vehicle that is turning by calculating an amount of movement made by the vehicle making a turn from the calculation starting-point position and calculating a post-movement position, by using the information based on the detection by the one or more on-board sensors, or an actual moving velocity of the vehicle that is turning, the actual moving velocity being oriented in a direction of a sideslip angle of the vehicle that is turning, the sideslip angle being calculated based on the information based on the detection by the one or more on-board sensors,
predict and determine interference with an obstacle to traveling, assuming that the vehicle moves along the predicted course of the vehicle that is turning, and
when the controller predicts and determines that the interference with the obstacle to traveling will occur, execute the collision mitigation process of causing one or both of the braking device and the steering system to operate.

2. The vehicle collision mitigation apparatus according to claim 1, wherein the controller is configured to set a central position of multiple wheels provided in the vehicle as the calculation starting-point position for the predicted course of the vehicle that is turning.

3. The vehicle collision mitigation apparatus according to claim 2, wherein the controller is configured to
calculate the sideslip angle with respect to a front-rear direction of the vehicle, based on a centripetal lateral velocity and a front-rear velocity, the centripetal lateral velocity being a velocity in a lateral direction of the vehicle that is obtained based on the detection by the one or more on-board sensors, the front-rear velocity being a velocity in the front-rear direction of the vehicle,
calculate a radius of the turn of the vehicle and a position of a center of the turn, based on a yaw rate of the vehicle at the calculation starting-point position and the actual moving velocity, the yaw rate being obtained based on the detection by the one or more on-board sensors, and
further calculate and generate the predicted course of the vehicle that is turning, assuming assumed that the vehicle that is turning makes a steady-state circular turn with the radius of the turn about the position of the center of the turn, in a direction of the actual moving velocity.

4. The vehicle collision mitigation apparatus according to claim 3, wherein the controller is configured to generate the predicted course of the vehicle that is turning that has a desired length, by repeatedly calculating the post-movement position based on a unit time or a unit amount of movement, assuming that the vehicle that is turning makes the steady-state circular turn with the radius of the turn about the position of the center of the turn, in the direction of the actual moving velocity.

5. The vehicle collision mitigation apparatus according to claim 1, wherein the controller is configured to
generate an interference determination plane on which an interference area of the interference, assuming that the vehicle travels along the predicted course of the vehicle that is turning at the actual moving velocity is set, and
predict and determine the interference with the obstacle to traveling, based on a position and a moving direction of the obstacle to traveling on the generated interference determination plane.

6. The vehicle collision mitigation apparatus according to claim 2, wherein the controller is configured to
generate an interference determination plane on which an interference area of the interference, assuming that the vehicle travels along the predicted course of the vehicle that is turning at the actual moving velocity is set, and
predict and determine the interference with the obstacle to traveling, based on a position and a moving direction of the obstacle to traveling on the generated interference determination plane.

7. The vehicle collision mitigation apparatus according to claim 3, wherein the controller is configured to
generate an interference determination plane on which an interference area of the interference, assuming that the vehicle travels along the predicted course of the vehicle that is turning at the actual moving velocity is set, and
predict and determine the interference with the obstacle to traveling, based on a position and a moving direction of the obstacle to traveling on the generated interference determination plane.

8. The vehicle collision mitigation apparatus according to claim 4, wherein the controller is configured to
generate an interference determination plane on which an interference area of the interference, assuming that the vehicle travels along the predicted course of the vehicle that is turning at the actual moving velocity is set, and
predict and determine the interference with the obstacle to traveling, based on a position and a moving direction of the obstacle to traveling on the generated interference determination plane.

9. A vehicle collision mitigation apparatus configured to cause a braking device or a steering system of a vehicle to operate and mitigate collision of the vehicle, the vehicle collision mitigation apparatus comprising:
at least one processor; and
one or more on-board sensors provided in the vehicle, the one or more on-board sensors comprising an accelerometer configured to perform a detection of at least an acceleration rate of the vehicle as a traveling state of the vehicle, wherein
the at least one processor is configured to
set a central position of the vehicle as a calculation starting-point position for a predicted course of the vehicle that is turning,
generate the predicted course of the vehicle that is turning by calculating an amount of movement made by the vehicle making a turn from the calculation starting-point position and calculating a post-movement position, by using information based on a detection by the one or more on-board sensors, or an actual moving velocity of the vehicle that is turning, the actual moving velocity being oriented in a direction of a sideslip angle of the vehicle that is turning, the sideslip angle being calculated based on the information based on the detection by the one or more on-board sensors,
predict and determine interference with an obstacle to traveling, assuming that the vehicle moves along the predicted course of the vehicle that is turning, and
when the at least one processor predicts and determines that the interference with the obstacle to traveling will occur, execute a collision mitigation process of causing one or both of the braking device and the steering system to operate.
